(19) United States
(12) Patent Application Publication
(10) Pub. No.: US 2017/0227422 A1
(43) Pub. Date: Aug. 10, 2017

(54) METHOD AND SYSTEM FOR SENSING POSITION OF MOVING OBJECT AND CLUTCH PISTON POSITION SENSING SYSTEM WTIH SLEEP FUNCTION

(71) Applicant: Tyco Electronics (Shanghai) Co. Ltd., Shanghai (CN)

(72) Inventor: Dawei CHENG, Shanghai (CN)

(21) Appl. No.: 15/423,967

(22) Filed: Feb. 3, 2017

(30) Foreign Application Priority Data
Feb. 6, 2016 (CN) 201610083830.4
Feb. 6, 2016 (CN) 201620119239.5

(51) Int. Cl. G01M 15/06; G01D 5/12; G01D 18/00; F16D 25/12

(52) U.S. Cl. CPC G01M 15/06; F16D 25/12; G01D 5/12; G01D 18/00; F16D 2300/18

(57) ABSTRACT

The invention provides a method and a system for sensing position of a moving object. A relatively long stroke of a moving object is divided into multiple areas. A sensing element is disposed in each area to sense a magnetic field signal when a magnet apparatus moves along with a moving object and passes through each area, and to generate a sensed signal of each area. A microcontrol unit receives sensed signals of segments and performs temperature compensation and correction on the sensed signals, then combines the sensed signal according to time and a stroke sequence to form a continuous moving-object movement signal that reflects the entire stroke. The invention also provides a clutch piston position sensing system with a sleep function, having a magnet apparatus disposed on the piston and moving along with the piston in the stroke; a sleep control circuit having a sleep sensing element and configured to sense a position of the magnet apparatus and generate a sleep control signal to control the clutch piston position sensing system to be in a started or sleep mode; and a microcontrol unit for receiving the sleep control signal and control the clutch piston position sensing system to be in a sleep or started state.

### CROSS-REFERENCE TO RELATED APPLICATIONS

This patent application claims the benefit of Chinese Priority Patent Application Nos. 201620119239.5 and 201610083830.4 both filed on Feb. 6, 2016 in China, the whole disclosure of which is incorporated herein by reference.

### TECHNICAL FIELD

The present invention relates generally to a method and system for sensing the position a moving object, and particularly to a method and system for sensing a movement position of a moving object with a relatively long stroke, for example, an apparatus for sensing a piston position of a clutch master cylinder of a vehicle engine. The present invention further relates to a clutch piston position sensing system with sleeping function.

### BACKGROUND

In control technology, a sensing device is often used to sense a movement position of a moving object. When a movement stroke of the moving object is relatively long and exceeds a sensing range of the sensing device, existing sensing devices cannot cover such a long stroke, and therefore cannot sense the position of the long-stroke moving object.

For example, in vehicle control technology, it is required to sense a clutch position of a vehicle engine and generate a clutch position signal. Currently, the clutch position signal may be generated by a sensing system mounted on a clutch master cylinder (or CMC). When a clutch pedal is stepped on, the existing sensing system mounted on the clutch master cylinder can generate a position signal of a movement of a clutch piston in a clutch stroke.

In case of a large vehicle such as a truck or the like, a stroke of a piston of its clutch master cylinder is relatively long. A movement stroke capable of being sensed by the existing clutch piston sensing apparatus cannot cover such a long-stroke piston movement.

### SUMMARY OF THE INVENTION

A first objective of the present invention is to provide a sensing method, so as to solve the foregoing problem.

According to a first aspect of the present invention, there is provided a moving-object movement position sensing method to sense a movement position of a moving object in one stroke, where a length of the stroke is divided into at least two strokes, and the moving object moves in the stroke to generate a movement position signal of the moving object in a first stroke and a movement position signal of the moving object in a second stroke. The sensing method comprises sensing the movement position signal of the moving object in the first stroke and the movement position signal of the moving object in the second stroke, and generating a first sensed signal and a second sensed signal respectively, where the first sensed signal and the second sensed signal change as the moving object moves in the corresponding first stroke and the corresponding second stroke; and combining the first sensed signal and the second sensed signal according to a stroke sequence (or time) to generate a whole sensed signal, where the whole sensed signal changes as the moving object moves in the stroke.

Preferably, the above-described sensing method further comprises: disposing a first sensing element corresponding to the first stroke, where the first sensing element is configured to sense a movement of the moving object passing through the first stroke, and generate the first sensed signal; and disposing a second sensing element corresponding to the second stroke, where the second sensing element is configured to sense a movement of the moving object passing through the second stroke, and generate the second sensed signal.

More preferably, the first sensing element senses in two-dimensional spatial direction the movement of the moving object in the first stroke to generate sine-shaped and cosine-shaped first periodic signals reflecting the movement of the moving object in the first stroke; and the second sensing element senses in two-dimensional spatial direction the movement of the moving object in the second stroke to generate sine-shaped and cosine-shaped second periodic signals reflecting the movement of the moving object in the second stroke.

In a preferred embodiment, the sensing method further comprises: performing analog-to-digital conversion on the first periodic signals sensed by the first sensing element; and performing analog-to-digital conversion on the second periodic signals sensed by the second sensing element.

In another preferred embodiment, the above-described sensing method further comprises converting the digital sine-shaped and cosine-shaped first periodic signals to the linear first sensed signal; and converting the digital sine-shaped and cosine-shaped second periodic signals to the linear second sensed signal.

In yet another preferred embodiment, the above-described sensing method further comprises sensing an ambient temperature of the sensing elements to obtain an ambient temperature signal; and performing temperature compensation on the first sensed signal and the second sensed signal according to the ambient temperature signal to obtain a first compensated sensed signal and a second compensated sensed signal with the same linear signal slope after the temperature compensation.

In another preferred embodiment, the above-described sensing method further comprises: storing different temperature compensation coefficients corresponding to different ambient temperature signals; and performing the temperature compensation on the first sensed signal and the second sensed signal according to different temperature compensation coefficients respectively to obtain the first compensated sensed signal and the second compensated sensed signal.

Preferably, the temperature compensation is performed by using the following calculation formula:

Tang_n=K×ang_n+b;

where K is a temperature compensation coefficient, b is an intercept, n is an integer greater than or equal to 1, ang_n is an nth sensed signal, and Tang_n is an nth compensated sensed signal.

In yet another embodiment, the above-described sensing method further comprises: correcting the first compensated sensed signal and the second compensated sensed signal respectively to obtain a first corrected sensed signal and a second corrected sensed signal; combining the first corrected sensed signal and the second corrected sensed signal according to a stroke sequence; and generating a linear whole sensed signal reflecting the movement of the piston in the entire stroke.

Preferably, the correcting the first compensated sensed signal and the second compensated sensed signal is performed by using the following calculation formula:

Lin_n=Sn×Tang_n+In;

where Lin_n is an nth corrected sensed signal after correction, Sn is a slope correction coefficient of an nth compensated sensed signal, In is an intercept adjustment coefficient of the nth compensated sensed signal, and n is an integer greater than or equal to 1.

Preferably, the linear first corrected sensed signal and the linear second corrected sensed signal after compensation and correction are combined according to the stroke sequence, where the combination according to the stroke sequence is performed by using the following calculation formula:

Snorm=Lin_1+Lin_2+Lin_3+Lin_4+ . . . +Lin_n;

where n is an integer greater than or equal to 1, and Snorm is a combined movement position signal.

In another preferred embodiment, the above-described sensing method further comprises: performing diagnosis on the corrected sensed signal, where the diagnosis is performed by using the following comparison formulas:

(1) If Lin_n<Work range LCL, output Lin_n=Clamp_Low;

(2) If Lin_n>Work range LCL, output Lin_n=Clamp_High; and

(3) If Work range LCL>Lin_n<Work range UCL, output Lin_n=Sn×Tang+In;

where Clamp_Low represents a signal output low clamp mode, Clamp_High represents a signal output high clamp mode, Work range LCL represents a minimum effective work range, and Work range UCL represents a maximum effective work range.

In one embodiment of the sensing method, a magnet apparatus is fixedly disposed on the moving object, where the magnet apparatus moves along with the moving object, and a movement of the magnet apparatus is sensed to determine the movement of the moving object.

In another embodiment of the sensing method, the sensing elements are 3D Hall sensing elements, where the 3D Hall sensing element senses a magnetic field signal of magnetic field intensity of the magnet apparatus in two directions of two-dimensional space, and the magnetic field signal is used as an operating signal to perform an operation.

Preferably, the moving object is a clutch piston, and the stroke is a movable distance in a piston cylinder.

According to a second aspect of the present invention, a moving-object movement position sensing system is provided. The moving-object movement position sensing system is configured to sense a movement position of a moving object in one stroke, where a length of the stroke is divided into at least two strokes, the moving object moves in the stroke to generate a movement position signal of the moving object in a first stroke and a movement position signal of the moving object in a second stroke. The moving-object movement position sensing system comprises:

multiple sensing elements configured to sense the movement position signal of the moving object in the first stroke and the movement position signal of the moving object in the second stroke, and generate a first sensed signal and a second sensed signal, respectively, where the first sensed signal and the second sensed signal change as the moving object moves in the corresponding first stroke and the corresponding second stroke; and

a microcontrol unit configured to combine the first sensed signal and the second sensed signal according to a stroke sequence (or time) to generate a whole sensed signal, where the whole sensed signal changes as the moving object moves in the stroke.

In an embodiment of the sensing system, the sensing elements comprise a first sensing element and a second sensing element, wherein the first sensing element is disposed in the first stroke, and is configured to sense a movement of the moving object passing through the first stroke, and generate the first sensed signal; and the second sensing element is disposed in the second stroke, and is configured to sense a movement of the moving object passing through the second stroke, and generate the second sensed signal.

Preferably, the first sensing element senses, in two directions of two-dimensional space, a movement of the moving object in the first stroke to generate sine-shaped and cosine-shaped first periodic signals reflecting the movement of the magnet apparatus in the first stroke; and the second sensing element senses, in the two directions of the two-dimensional space, a movement of the moving object in the second stroke to generate sine-shaped and cosine-shaped second periodic signals reflecting the movement of the magnet apparatus in the second stroke.

Preferably, the microcontrol unit performs analog-to-digital conversion on the sensed first periodic signals; and the microcontrol unit performs analog-to-digital conversion on the sensed second periodic signals.

Preferably, the microcontrol unit converts the digital sine-shaped and cosine-shaped first periodic signals to the linear first sensed signal; and the microcontrol unit converts the digital sine-shaped and cosine-shaped second periodic signals to the linear second sensed signal.

In another embodiment, the above-described sensing system further comprises a temperature sensing circuit, where the temperature sensing circuit senses an ambient temperature of the sensing elements to obtain an ambient temperature signal; and the microcontrol unit performs temperature compensation on the first sensed signal and the second sensed signal according to the ambient temperature signal to obtain a first compensated sensed signal and a second compensated sensed signal with the same linear signal slope after the temperature compensation.

In yet another embodiment of the above-described sensing system, the microcontrol unit stores different temperature compensation coefficients corresponding to different ambient temperature signals; and the microcontrol unit performs the temperature compensation on the first sensed signal and the second sensed signal according to different temperature compensation coefficients respectively to obtain the first compensated sensed signal and the second compensated sensed signal.

Preferably, the microcontrol unit performs the temperature compensation by using the following calculation formula:

Tang_n=K×ang_n+b

where K is a temperature compensation coefficient, b is an intercept, n is an integer greater than or equal to 1, ang_n is an nth sensed signal, and Tang_n is an nth compensated sensed signal.

In an embodiment of the above-described sensing system, the microcontrol unit corrects the first compensated sensed signal and the second compensated sensed signal respectively to obtain a first corrected sensed signal and a second corrected sensed signal; and the microcontrol unit combines the first corrected sensed signal and the second corrected sensed signal according to a stroke sequence, and generates a linear whole sensed signal reflecting the movement of the piston in the entire stroke.

In a preferred embodiment of the above-described sensing system, the microcontrol unit corrects the first compensated sensed signal and the second compensated sensed signal by using the following calculation formula:

Lin_n=Sn×Tang_n+In;

where Lin_n is an nth corrected sensed signal after correction, Sn is a slope correction coefficient of an nth compensated sensed signal, In is an intercept adjustment coefficient of the nth compensated sensed signal, and n is an integer greater than or equal to 1.

In another embodiment of the above-described sensing system, the microcontrol unit combines, according to the stroke sequence in a time sharing manner, the first corrected sensed signal and the second corrected sensed signal after correction, where the combination according to the stroke sequence is performed by using the following calculation formula:

Snorm=Lin_1+Lin_2+Lin_3+Lin_4+ . . . +Lin_n;

where n is an integer greater than or equal to 1, and Snorm is a combined movement position signal.

Preferably, the microcontrol unit performs diagnosis on the corrected sensed signal; and the diagnosis is performed by using the following comparison formulas:

(1) If Lin_n<Work range LCL, output Lin_n=Clamp_Low;

(2) If Lin_n>Work range LCL, output Lin_n=Clamp_High; and

(3) If Work range LCL>Lin_n<Work range UCL, output Lin_n=Sn×Tang+In;

where Clamp_Low represents a signal output low clamp mode, Clamp_High represents a signal output high clamp mode, Work range LCL represents a minimum effective work range, and Work range UCL represents a maximum effective work range.

In another embodiment, the above-described sensing system further comprises a voltage conversion circuit configured to adjust an operating voltage of the sensing system to 5V.

In yet another embodiment, the above-described sensing system further comprises a sleep control circuit provided with a sleep sensing element and configured to sense a position of the moving object and generate a sleep control signal, where the microcontrol unit receives the sleep control signal and controls the sensing system to be in a started or sleep mode.

Preferably, the sleep control circuit senses a position of the moving object; and when the moving object is driven to a first set position, the sleep control circuit sends a startup control signal; and when the moving object is driven to a second set position, the sleep control circuit sends a sleep control signal.

In a preferred embodiment of the above-described sensing system, the startup control signal is a rising edge step signal, and after receiving the startup control signal, the microcontrol unit enables the sensing system to output a normal signal after outputting a startup first character for 1 ms; and the sleep control signal is a falling edge step signal, and after receiving the sleep control signal, the microcontrol unit enables the sensing system to output no signal after outputting the normal signal for 2.5 ms.

In another preferred embodiment of the above-described sensing system, the magnet apparatus is fixedly disposed on the moving object, and the magnet apparatus moves along with the moving object.

Preferably, the sensing elements are 3D Hall sensing elements, where the 3D Hall sensing element senses a magnetic field signal of magnetic field intensity of the magnet apparatus in two directions of the two-dimensional space, and the magnetic field signal is used as an operating signal to perform an operation.

Preferably, the moving object is a clutch piston, and the stroke is a movable distance of the clutch piston in a piston cylinder.

In another embodiment, the above-described sensing system further comprises a magnetism aggregation member additionally provided outside the piston cylinder and configured to enhance magnetic field extension strength of the magnet apparatus.

In yet another embodiment, the above-described sensing system further comprises a PCB board, where the multiple sensing elements are disposed on one side of the PCB board; and the magnetism aggregation member is disposed on the other side of the PCB board, and the magnetism aggregation member is aligned with the multiple sensing elements.

A second objective of the present invention is to provide an apparatus. A specific embodiment is as follows:

According to a first aspect of the present invention, there is provided a clutch piston position sensing system with a sleep function used to sense a movement position of a clutch piston in one stroke. The clutch piston position sensing system comprises a magnet apparatus disposed on the piston and moving along with the piston in the stroke; a sleep control circuit provided with a sleep sensing element and configured to sense a position of the magnet apparatus and to generate a sleep control signal to control the clutch piston position sensing system to be in a start or sleep mode; and a microcontrol unit configured to receive the sleep control signal and control the clutch piston position sensing system to be in a sleep or started state.

In a preferable embodiment of the clutch piston position sensing system, the sleep control circuit senses a position of the piston, when the piston is driven to a first set position, the sleep control circuit sends a startup control signal; and when the piston is driven to a second set position, the sleep control circuit sends the sleep control signal.

In a more preferable embodiment of the clutch piston position sensing system, the startup control signal is a rising edge step signal, and after receiving the startup control signal, the microcontrol unit enables the clutch piston position sensing system to output a normal signal after outputting a startup first character for 1 ms; and the sleep control signal is a falling edge step signal, and after receiving the sleep control signal, the microcontrol unit enables the clutch piston position sensing system to output no signal after outputting the normal signal for 2.5 ms.

In one more preferable embodiment of the clutch piston position sensing system, the microcontrol unit receives the startup control signal, and controls the clutch piston position sensing system to be in a started state; and the microcontrol unit receives the sleep control signal, and controls the clutch piston position sensing system to be in a sleep state.

In another embodiment of the clutch piston position sensing system, a length of the stroke is divided into at least two strokes (S1, S2): a first stroke (S1) and a second stroke (S2), respectively; and the piston moves in the stroke to generate a movement position signal (yd1) of the piston in the first stroke (S1) and a movement position signal (yd2) of the piston in the second stroke (S2).

Preferably, the clutch piston position sensing system comprises: sensing elements configured to respectively sense the movement position signal (yd1) of the piston in the first stroke (S1) and the movement position signal (yd2) of the piston in the second stroke (S2), and generate a first sensed signal (ang_1) and a second sensed signal (ang_2), where the first sensed signal (ang_1) and the second sensed signal (ang_2) change as the piston moves in the corresponding first stroke (S1) and the corresponding second stroke (S2); and the microcontrol unit configured to combine the first sensed signal (ang_1) and the second sensed signal (ang_2) according to a stroke sequence to generate a whole sensed signal (Snorm) where the whole sensed signal (Snorm) changes as the piston moves in the stroke.

More preferably, the sensing elements comprise a first sensing element and a second sensing element, where the first sensing element is disposed in the first stroke (S1) and configured to sense a movement of the clutch piston passing the first stroke (S1) and to generate the first sensed signal (ang_1); and the second sensing element is disposed in the second stroke (S2) and configured to sense a movement of the clutch piston passing the second stroke (S2) and to generate the second sensed signal (ang_2).

More preferably, the first sensing element senses, in two directions of two-dimensional space, a movement of the magnet apparatus in the first stroke (S1) and generates sine-shaped and cosine-shaped first periodic signals (Bx_1, By_1) that reflect the movement of the magnet apparatus in the first stroke (S1); and the second sensing element senses, in the two directions of the two-dimensional space, a movement of the magnet apparatus in the second stroke (S2) and generates sine-shaped and cosine-shaped second periodic signals (Bx_2, By_2) that reflect the movement of the magnet apparatus in the second stroke (S2).

More preferably, the microcontrol unit performs analog-to-digital conversion on the sensed first periodic signals (Bx_1, By_1). The microcontrol unit performs analog-to-digital conversion on the sensed second periodic signals (Bx_2, By_2).

More preferably, the microcontrol unit converts the digital sine-shaped and cosine-shaped first periodic signals (Bx_1, By_1) to the linear first sensed signal (ang_1); and the microcontrol unit converts the digital sine-shaped and cosine-shaped second periodic signals (Bx_2, By_2) to the linear second sensed signal (ang_2).

In another preferred embodiment, the above-described clutch piston position sensing system further comprises a temperature sensing circuit, where the temperature sensing circuit senses an ambient temperature of the sensing elements to obtain an ambient temperature signal (Temp); and the microcontrol unit performs temperature compensation on the first sensed signal (ang_1) and the second sensed signal (ang_2) according to the ambient temperature signal (Temp) to obtain a first compensated sensed signal (Tang_1) and a second compensated sensed signal (Tang_2) with consistent linear signal slopes after the temperature compensation.

More preferably, the microcontrol unit stores different temperature compensation coefficients corresponding to different ambient temperature signals; and the microcontrol unit performs the temperature compensation on the first sensed signal (ang_1) and the second sensed signal (ang_2) respectively according to different temperature compensation coefficients to obtain the first compensated sensed signal (Tang_1) and the second compensated sensed signal (Tang_2).

More preferably, the microcontrol unit performs the temperature compensation by using the following calculation formula:

Tang_n=K×ang_n+b

where K is a temperature compensation coefficient, b is an intercept, n is an integer greater than or equal to 1, ang_n is an nth sensed signal, and Tang_n is an nth compensated sensed signal.

Preferably, the microcontrol unit corrects the first compensated sensed signal (Tang_1) and the second compensated sensed signal (Tang_2) to obtain a first corrected sensed signal (Lin_1) and a second corrected sensed signal (Lin_2) after correction, and also combines the first corrected sensed signal (Lin_1) and the second corrected sensed signal (Lin_2) according to the stroke sequence to generate the whole sensed signal (Snorm) reflecting the movement of the piston in the entire stroke.

More preferably, the microcontrol unit corrects the first compensated sensed signal (Tang_1) and the second compensated sensed signal (Tang_2) by using the following calculation formula:

Lin_n=Sn×Tang_n+In

where Lin_n is an nth corrected sensed signal after correction, Sn is a slope correction coefficient of an nth compensated sensed signal, In is an intercept adjustment coefficient of the nth compensated sensed signal, and n is an integer greater than or equal to 1.

More preferably, the microcontrol unit combines, according to the stroke sequence, the first corrected sensed signal (Lin_1) and the second corrected sensed signal (Lin_2) after correction, where the combination according to the stroke sequence is performed by using the following calculation formula:

Snorm=Lin_1+Lin_2+Lin_3+Lin_4+ . . . +Lin_n

where n is an integer greater than or equal to 1, and Snorm is a combined movement position signal.

More preferably, the microcontrol unit performs diagnosis on the corrected sensed signal (Lin_n) where the diagnosis is performed by using the following comparison formulas:

(1) if Lin_n<Work range LCL, output Lin_n=Clamp_Low;

(2) if Lin_n>Work range LCL, output Lin_n=Clamp_High; and

(3) if Work range LCL>Lin_n<Work range UCL, output Lin_n=Sn×Tang+In;

where Clamp_Low represents a signal output low clamp mode, Clamp_High represents a signal output high clamp mode, Work range LCL represents a minimum effective work range, Work range UCL represents a maximum effective work range, Lin_n is an nth corrected sensed signal after correction, Tang_n represents an nth compensated sensed signal, Sn is a slope correction coefficient of the nth compensated sensed signal, and In is an intercept adjustment coefficient of the nth compensated sensed signal.

In yet another embodiment, the clutch piston position sensing system further comprises a voltage conversion circuit configured to adjust an operating voltage of the sensing system to 5 V.

Preferably, the clutch piston position sensing system further comprises sensing elements where all the sensing elements are fixedly mounted on the clutch piston cylinder. More preferably, the sensing elements are 3D Hall sensing elements.

In a more preferred embodiment, the above-described clutch piston position sensing system further comprises a magnetism aggregation member additionally provided outside the piston cylinder and configured to enhance magnetic field extension strength of the magnet apparatus.

In another preferred embodiment, the clutch piston position sensing system further comprises a PCB board, where the sensing elements are disposed on one side of the PCB board; and the magnetism aggregation member is disposed on the other side of the PCB board, and the magnetism aggregation member is aligned with the sensing elements.

According to the method and system for sensing position of a moving object of the present invention, for example, clutch piston position sensing, in order to sense a piston movement with a relatively long stroke, the stroke of a piston is divided into several areas. A Hall sensor is disposed in each area to sense a magnet moving along with the piston and passing through each area, and generates a sensed signal of each area. After receiving sensed signals of segments, a microcontrol unit performs processing such as temperature compensation, correction, timing-based combination and the like on the sensed signals, and then superimposes the sensed signals to form a continuous piston movement signal that reflects the entire stroke, thereby achieving the objective of sensing a long-stroke piston movement.

In addition, according to the sensing system and method, a temperature sensing circuit is further provided, and configured to sense a temperature of sensing elements to provide a temperature compensation correction parameter. A magnetism aggregation member is further disposed outside a piston cylinder to enhance and extend magnetic field distribution of a magnet on the piston. A sleep control circuit is further provided, to monitor whether the piston is driven, and provide a monitoring signal, enabling the entire sensing system to be control in a sleep or started state, thereby conserving energy. The entire invention improves sensing of a long-stroke piston movement with respects to magnetic circuit design, circuit design, and a software algorithm.

According to the piston movement position sensing system with a sleep function of the present invention, for example, clutch piston position sensing, in order to sense a piston movement with a relatively long stroke, the stroke of a piston is divided into several areas. A Hall sensor is separately disposed in each area to sense a magnet moving along with the piston and passing each area, and generates a sensed signal of each area. After receiving sensed signals of segments, a microcontrol unit performs processing such as temperature compensation, correction, timing-based combination and the like on the sensed signals, and then superimposes the sensed signals to form a continuous piston movement signal that reflects the entire stroke, thereby achieving the objective of sensing a long-stroke piston movement.

In addition, according to the sensing system, a temperature sensing circuit is further provided and configured to sense a temperature of sensing elements to provide a temperature compensation correction parameter. A magnetism aggregation member is further disposed outside a piston cylinder to enhance and extend magnetic field distribution of a magnet on the piston. A sleep control circuit is further provided to monitor whether the piston is driven and provide a monitoring signal, enabling the entire sensing system to be control in a sleep or started state to save energy. The entire invention improves sensing of a long-stroke piston movement with respects to magnetic circuit design, circuit design, and a software algorithm.

### BRIEF DESCRIPTION OF DRAWINGS

The following description is set forth in connection with the attached drawing figures, which are not necessarily to scale, emphasis instead generally being placed upon illustrating the principles of the invention. In the drawing figures:

FIG. 1 is a schematic structural view of an application of a moving-object position sensing system in a clutch piston according to the present invention;

FIG. 2 is a schematic view of a circuit configuration of a clutch piston position sensing system according to the present invention;

FIG. 3 is a schematic structural view of a chip select circuit of a microcontrol unit according to the present invention;

FIG. 4 is a schematic structural view of an internal circuit of a microcontrol unit according to the present invention;

FIG. 5 is a schematic view of a circuit configuration of a temperature sensing circuit according to the present invention;

FIG. 6A is a schematic waveform diagram of two sine-shaped and cosine-shaped periodic signals sensed by a sensing unit according to the present invention;

FIG. 6B is a schematic waveform diagram of a linear sensed signal converted from the sine and cosine signals in FIG. 6A;

FIG. 7A is a schematic signal diagram of sensed signals of each of the three segments into which a stroke is divided according to an embodiment of the present invention;

FIG. 7B is a schematic diagram of the temperature-compensated sensed signals obtained from the sensed signals of each of the three segments into which a stroke is divided according to the foregoing embodiment of the present invention;

FIG. 7C is a schematic diagram of the temperature-compensated sensed signals obtained from the sensed signals of each of the three segments into which a stroke is divided according to the foregoing embodiment of the present invention;

FIG. 8 is a schematic flowchart of signal processing according to the present invention;

FIG. 9 is a schematic flowchart of detection and diagnosis processing performed on a corrected sensed signal according to the present invention; and

FIG. 10 is a schematic waveform diagram of sensed signals at different temperatures according to the present invention.

### DETAILED DESCRIPTION OF THE EMBODIMENTS

Various embodiments of the present invention will be described below with reference to the accompanying drawings constituting a part of the specification. It should be understood that although directional terms, such as “front,” “back,” “above,” “below,” “left,” “right” and the like, are used in the present invention to describe various exemplary structures and elements of the present invention, these terms used herein are only for ease of description, and are determined based on exemplary directions shown in the accompanying drawings. The embodiments disclosed by the present invention may be disposed according to different directions, and therefore these directional terms are only intended for description, and should not be construed as a limitation. In possible cases, identical or similar reference numerals used in the present invention denote identical components.

In control technology, usually a sensing apparatus is used to sense a movement position of a moving object. For example, a magnet is fixed on the moving object, and a sensing apparatus such as a Hall sensor or the like is used to sense a magnetic field signal of the magnet, and a movement signal of the magnet apparatus reflects a movement of the moving object. However, when a movement stroke of the moving object is relatively long and exceeds a sensing range of the sensing apparatus, the existing sensing apparatus cannot cover such a long stroke, and therefore cannot accomplish position sensing of such a long-stroke moving object. In order to solve the problem, the present invention is demonstrated by using position sensing of a reciprocating movement of a vehicle clutch piston as an embodiment to illustrate how a movement of a long-stroke moving object is sensed by using a moving-object sensing method of the present invention. Certainly, the moving-object sensing method and apparatus of the present invention are not limited to only sensing of vehicle clutch piston position.

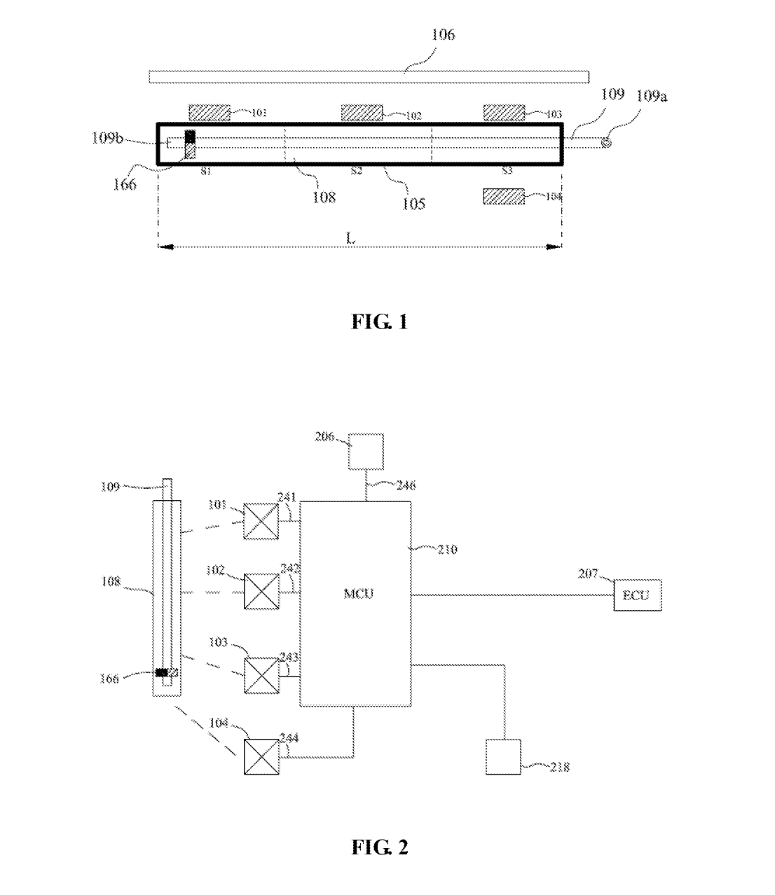

FIG. 1 is a schematic structural view of an application of a moving-object position sensing system in a clutch piston according to the present invention.

Taking a movement of a vehicle clutch piston as an example, FIG. 1 illustrates an internal structure of a piston cylinder 105 and a schematic matching relationship between a clutch piston 109 and a piston cylinder chamber 108. As shown in FIG. 1, a clutch master piston assembly comprises the piston cylinder 105. The piston cylinder 105 has a chamber 108. The piston 109 extends into the piston cylinder chamber 108, and can move back and forth linearly in the piston cylinder chamber 108. For example, a proximal end 109a of the piston 109 is driven by a clutch pedal (not shown), and as the clutch pedal is stepped down and released, the piston 109 moves linearly back and forth. A distal end 109b of the piston 109 is provided with a magnet apparatus 166 (as an embodiment, the magnet apparatus 166 may be, e.g., a ring magnet around the piston 109), and the magnet apparatus 166 is adapted to perform a reciprocating (or other) movement in the piston cylinder chamber 108 along with a linear movement of the piston 109. In an embodiment shown in FIG. 1, the magnet apparatus 166 moves back and forth between a cylinder top position and a cylinder bottom position along with the piston 109. Although not shown in the drawing, the magnet apparatus 166 may also be disposed and mounted in another position along an axial direction of the piston 109. The proximal end 109a of the piston 109 is driven by the clutch pedal, and therefore a corresponding position of the magnet apparatus 166 in the piston cylinder 105 reflects an operating position of the clutch pedal, and thereby reflects a corresponding operating position of a clutch.

In FIG. 1, the magnet apparatus 166 mounted on the piston 109 moves in the chamber 108 of the piston cylinder 105, a movable total distance is L. In an embodiment, the movable total distance L is evenly divided into three segments: a first stroke S1, a second stroke S2, and a third stroke S3, respectively (alternatively, the total distance L may not be divided evenly).

The clutch piston position sensing system are provided with multiple sensing elements on an outer wall of the piston cylinder 105, such as a first sensing element 101, a second sensing element 102, and a third sensing element 103. The first sensing element 101, the second sensing element 102, and the third sensing element 103 are disposed on the first stroke S1, the second stroke S2, and the third stroke S3 respectively. The multiple sensing elements may be configured as one of multiple types of sensing elements, for example, 3D Hall sensing elements. The first sensing element 101, the second sensing element 102, and the third sensing element 103 sense a magnetic field signal when the magnet apparatus 166 moves along with the piston 109 to the first stroke S1, the second stroke S2, and the third stroke S3, respectively. The sensing elements may be fixed on the piston cylinder 105 by multiple means. For example, the sensing elements are mounted on the outer wall of the piston cylinder 105 by a mounting rack 110. In the embodiment shown in FIG. 1, positions of the sensing elements along the axial direction of the piston cylinder 105 correspond to areas in which the magnet apparatus 166 moves back and forth between the cylinder top position and the cylinder bottom position. When the magnet apparatus 166 is in any position between the cylinder bottom position and the cylinder top position, a detection circuit in the sensing element senses a change in a magnetic field (or magnetic flux) generated by the magnet apparatus 166.

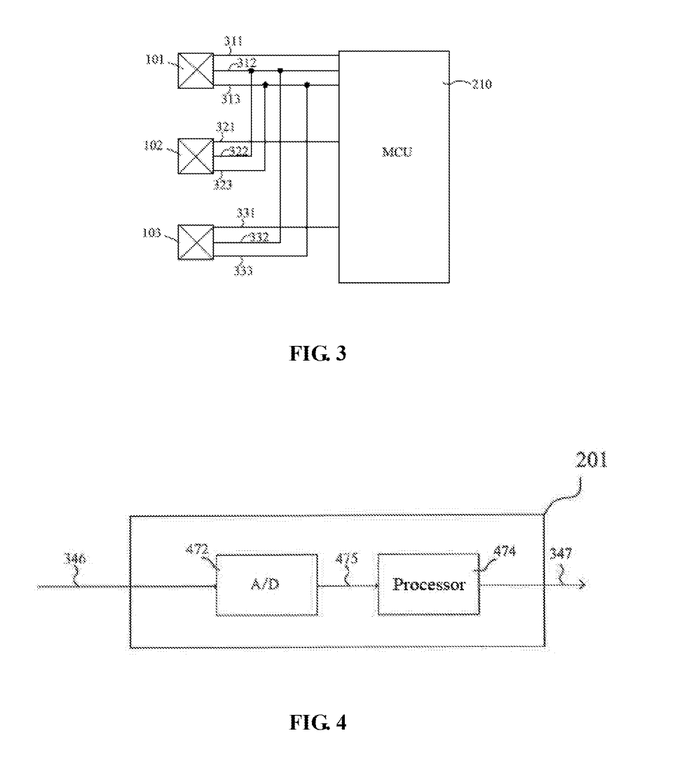

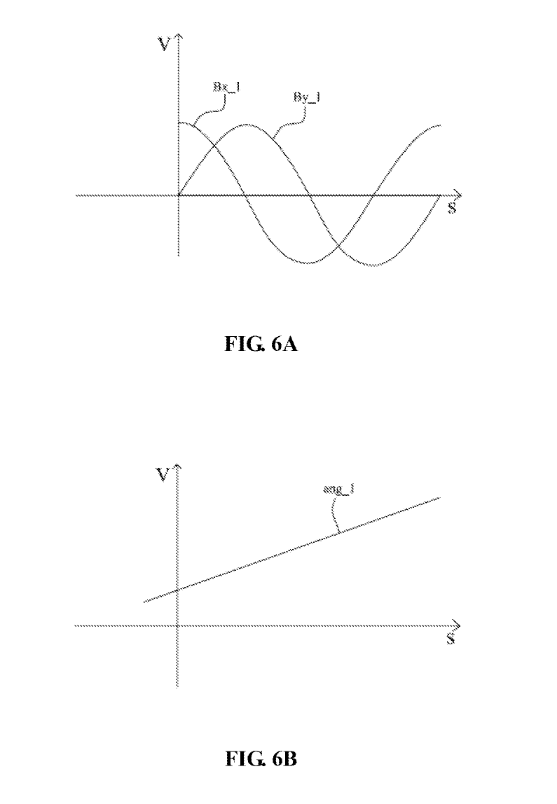

During working of the system, when the magnet apparatus 166 moves along with the piston 109 among the first stroke S1, the second stroke S2, and the third stroke S3 of the piston cylinder 105, the magnetic field (or the magnetic flux) generated at the first sensing element 101, the second sensing element 102, and the third sensing element 103 by the magnet apparatus 166 changes correspondingly. The detection circuits in the first sensing element 101, the second sensing element 102, and the third sensing element 103 that are disposed on the outer wall of the piston cylinder 105 sense the change in the magnetic field (or the magnetic flux) of the magnet apparatus 166, and pick up corresponding data at a specific time to generate signals for indicating a clutch position (see FIG. 3). In this embodiment of the present invention, the signals indicating the clutch position that are generated by the first sensing element 101, the second sensing element 102, and the third sensing element 103 being 3D Hall sensing elements comprise sine-shaped and cosine-shaped periodic signals Bx_1 and By_1, Bx_2 and By_2, and Bx_3 and By_3 that are generated by sensing, in X and Y (or Z direction) directions in two-dimensional space, movements of the magnet apparatus 166 in each stroke (S1, S2, S3) (see FIG. 6A).

Additionally, a sleep sensing element 104 (for example, a 3D Hall sensing element) is further disposed on the outer wall of the piston cylinder 105, and is configured to sense the position of the piston 109 and generate a sleep control signal CTS. The sleep control signal CTS indicates that the clutch is stepped on and leaves a free state, and the magnet apparatus 166 reaches the cylinder top position (a set position) in which a separation force is just applied to a clutch friction plate while the clutch friction plate is in an abutting position, and a gearbox and an engine are in an engaged state. A microcontrol unit 210 receives the sleep control signal CTS, and controls the sensing system to be in a started or sleep mode (see FIG. 2).

The sleep control signal CTS comprises a startup control signal and a sleep control signal. The startup control signal is a rising edge step signal. After receiving the startup control signal, the microcontrol unit 210 enables the sensing system to output a normal signal after outputting a startup first character of 1 ms. The sleep control signal is a falling edge step signal. After receiving the sleep control signal, the microcontrol unit 210 enables the sensing system to output no signal after outputting the normal signal of 2.5 ms. When the clutch is not stepped on, the microcontrol unit 210 is in a standby sleep state. When the microcontrol unit 210 switches from the sleep state to a started state, it is not required to re-initialize all components, so that system startup time is saved, and the system in the sleep state conserves energy.

Further, a magnetism aggregation member 106 is additionally provided outside the piston cylinder 105. The magnetism aggregation member 106 is an iron strip (or other magnetic conduction materials), disposed on one side of the stroke of the movement of the magnet apparatus 166, aligned with the multiple sensing elements (101, 102, 103), and configured to enhance magnetic field extension strength of the magnet apparatus 166, so as to elongate a magnetic field distribution range.

In addition, the sensing system further comprises a PCB board (omitted in the drawing), and the multiple sensing elements (101, 102) disposed on one side of the PCB board; and the magnetism aggregation member 106 disposed on the other side of the PCB board, wherein the magnetism aggregation member is aligned with the multiple sensing elements (101, 102).

FIG. 2 is a schematic view of a circuit configuration of a clutch piston position sensing system according to the present invention. As shown in FIG. 2, the circuit configuration of the clutch piston position sensing system comprises a first sensing element 101, a second sensing element 102, a third sensing element 103, a sleep sensing element 104, a microcontrol unit 210, and the like. As shown in FIG. 1, a moving piston 109 is in a piston cylinder 105, and a magnet apparatus 166 is fixed on the piston 109. The first sensing element 101, the second sensing element 102, the third sensing element 103, and a sleep sensing element 104 that sense a movement of the magnet apparatus 166 are disposed outside the piston cylinder 105.

The first sensing element 101, the second sensing element 102, the third sensing element 103, and the sleep sensing element 104 operate independently, and sense magnetic flux density and/or a magnetic field generated by the magnet apparatus 166 in different positions, respectively, and then generate and output corresponding analog voltage signals complying with function lines, for example, sine-shaped or cosine-shaped analog voltage signals (see FIG. 6A for details). The microcontrol unit 210 performs processing, analysis, and diagnosis on the signals (see FIG. 6A to FIG. 9 for a specific process), and finally sends a processed piston position signal to an Electronic Control Unit (ECU) 207, commonly known as a driving computer. The ECU 207 is used to control vehicle driving.

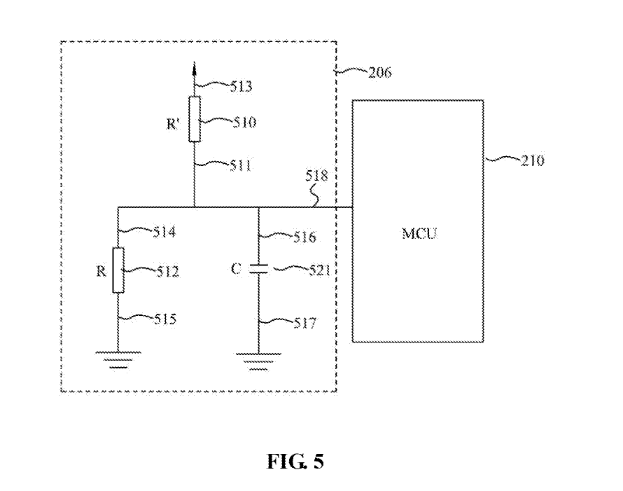

Furthermore, the clutch piston position sensing system further comprises a temperature sensing circuit 206. The temperature sensing circuit 206 senses operating temperatures of the first sensing element 101, the second sensing element 102, and the third sensing element 103 to obtain an ambient temperature signal Temp, and provides the ambient temperature signal Temp for the microcontrol unit 210 by a line 246. The microcontrol unit 210 performs temperature compensation on the sensed signal ang_n according to the ambient temperature signal Temp (see FIG. 5 for details).

In addition, the clutch piston position sensing system further comprises a voltage conversion circuit 218 configured to adjust an operating voltage of the entire sensing system to 5V.

FIG. 3 is a schematic structural view of a chip select circuit of a microcontrol unit according to the present invention.

When the magnet apparatus 166 passes through positions of the first sensing element 101, the second sensing element 102, and the third sensing element 103 at different times, the microcontrol unit 210 needs to select, at different times, sensed signals sent by the first sensing element 101, the second sensing element 102, and the third sensing element 103. A serial chip select circuit structure shown in FIG. 3 explains how the microcontrol unit 210 selects, at different times, signals sensed by the different sensing elements. As shown in FIG. 3, the first sensing element 101 is provided with three communication ports to communicate with the microcontrol unit 210, which are a chip select port 311, a clock port 312, and a data transmission port 313, respectively. Similarly, the second sensing element 102 and the third sensing element 103 are each respectively provided with a chip select port 321, 331, a clock port 322, 332, and a data transmission port 323, 333 to communicate with the microcontrol unit 210. By the clock port 312, the clock port 322, and the clock port 332, the microcontrol unit 210 simultaneously sends a clock signal SCLK of the same frequency to the first sensing element 101, the second sensing element 102, and the third sensing element 103, and meanwhile, at a different time or at a time when the magnet apparatus 166 passes through a sensing element (the first sensing element 101, the second sensing element 102, or the third sensing element 103), the microcontrol unit 210 sends a chip select signal SS to the sensing element by the chip select port (311, 321, or 331). The sensing unit that receives the chip select signal SS, for example the first sensing unit 101, sends a data packet signal to the microcontrol unit 210 by the data transmission port 313. A data packet signal in this embodiment is 8-bit (or 16-bit, or else), and is an X-direction magnetic field signal, a Y-direction magnetic field signal, a Z-direction magnetic field signal, a combined magnetic field (X+Y+Z) signal, a whether-lower-than-effective-magnetic-field determining signal, a whether-higher-than-effective-magnetic-field determining signal, a whether-signal-absence, or a whether-power-supply-being-normal signal, respectively. The microcontrol unit 210 parses all continuously received signal information from the first sensing element 101, the second sensing element 102, and the third sensing element 103. A subsequent section of the specification focuses on description of analysis and processing of the sensed piston position signals comprising the X-direction magnetic field signal, the Y-direction magnetic field signal, and the Z-direction magnetic field signal.

FIG. 4 is a schematic structural view of an internal circuit of a microcontrol unit according to the present invention.

FIG. 4 is a block diagram of an embodiment of a specific structure of a micro-processing unit 201. As shown in FIG. 4, the micro-processing unit 210 comprises at least an analog-to-digital (A/D) conversion circuit 472 and a processor 474. For example, in a preferred embodiment of the present invention, the first sensing element 101, the second sensing element 102, and the third sensing element 103 each sense a change in magnetic flux density and/or a change in a magnetic field in two dimensions (for example, Bx, By or Bz dimension), and generate analog voltage signal (movement signal EPB) outputs fitting two function lines (for example, one output curve is a cosine-shaped analog voltage signal output, and the other output curve is a sine-shaped analog voltage signal output). The first sensing element 101, the second sensing element 102, and the third sensing element 103 each at a different time transmit the cosine-shaped analog voltage signal output and the sine-shaped analog voltage signal output thereof to the analog-to-digital (A/D) conversion circuit 472.

The analog-to-digital (A/D) conversion circuit 472 converts the two cosine-shaped analog voltage signal outputs (or the two sine-shaped analog voltage signal outputs) respectively generated by and received from the first sensing element 101, the second sensing element 102, and the third sensing element 103 into digital signal outputs. The processor 474 processes Bx and By that have been converted into digital signals.

FIG. 5 is a schematic view of a circuit configuration of a temperature sensing circuit according to the present invention.

FIG. 5 illustrates a specific embodiment of the temperature sensing circuit 206 of the present invention. As shown in FIG. 5, the temperature sensing circuit 206 comprises a thermistor 510, a fixed resistor 512, and a capacitor 521. A lower end 511 of the thermistor 510 is connected in series to an upper end 514 of the fixed resistor 512, and an upper end 513 of the thermistor 510 in series is connected to a 5V voltage, and a lower end 515 of the fixed resistor 512 is grounded, and an upper end 516 of the capacitor 521 is connected to a lower end 511 of the thermistor 510 and the upper end 514 of the fixed resistor 512, and a lower end 517 of the capacitor 521 is grounded. The lower end 511 of the thermistor 510 is connected to an input end 518 of the micro-processing unit 210. The thermistor 510 and the fixed resistor 512 that are connected in series form a voltage division circuit. The thermistor 510 has a characteristic of changing resistance with an ambient temperature, and when the temperature changes, the resistance of the thermistor 510 changes. When the thermistor 510 is connected in series to the fixed resistor 512, the larger the resistance thereof is, the greater the divided voltage is, so that different voltage signals can be provided for the micro-processing unit 210. Multiple thermistors 510 are disposed at the first sensing element 101, the second sensing element 102, and the third sensing element 103 respectively, and the micro-processing unit 210 obtains ambient temperature signals Temp_1, Temp_2, and Temp_3 of the first sensing element 101, the second sensing element 102, and the third sensing element 103.

FIG. 6A is a schematic waveform diagram of two sine-shaped and cosine-shaped periodic signals sensed by a sensing unit according to the present invention.

Each of the 3D Hall sensing elements 101, 102, and 103 can sense, in multiple dimensions such as X, Y, and Z dimensions, the magnetic flux density and/or the magnetic field generated by the magnet apparatus 166 in different positions. Taking the first sensing element 101 as an example, the 3D Hall sensing element 101 can sense the magnetic flux density and/or the magnetic field in two dimensions (X, Y or Z dimensions), and generate two sine-shaped or cosine-shaped periodic signals Bx_1 and By_1. The micro-processing unit 210 of the present invention adapts the signals as position signals for calculating a piston movement. Taking the Bx_1 and By_1 as examples, the signal waveforms of the Bx_1 and By_1 are shown in FIG. 6A, where the Bx_1 is sine-shaped, and the By_1 is cosine-shaped.

Similarly, the second sensing element 102 and the third sensing element 103 also sense the change in the magnetic flux of the magnet apparatus 166 in the X, Y or Z dimensions, and generate two sets of signals Bx_2 and By_2, and Bx_3 and By_3 respectively. The micro-processing unit 210 adapts the signals as position signals for calculating the piston movement.

FIG. 6B is a schematic waveform diagram of a linear sensed signal converted from the sine and cosine signals in FIG. 6A.

As described above, the three sets of signals Bx_1 and By_1, Bx_2 and By_2, and Bx_3 and By_3 that are generated by the first sensing element 101, the second sensing element 102, and the third sensing element 103 respectively by sensing, in two dimensions, the change in the magnetic flux density and/or the change in the magnetic field as the magnet apparatus 166 moves back and forth in the chamber 108 of the piston cylinder are sent to the micro-processing unit 210, and the three sets of signals are voltage outputs fitting sine and cosine function lines.

The micro-processing unit 210 converts the three sets of analog signals into digital signals by using the analog-to-digital (A/D) conversion circuit 472, then selects two signals (one is a cosine-shaped voltage output, and the other is a sine-shaped voltage output) of each set of signals, and transmits the selected signals to the processor 474. The processor 474 converts the cosine digital voltage signal and the sine digital voltage signal transmitted from the analog-to-digital (A/D) conversion circuit 472 into one linear voltage output. Taking the Bx_1 and By_1 input by the first sensing element 101 as examples, a calculation method is shown by the following formula:

ang_1=MOD(a tan 2(Bx_1,By_1)*180/PI,360).

In the foregoing calculation formula, an effective stroke Lx2 of the magnet apparatus 166 in the chamber 108 of the piston cylinder corresponds to one circumference. Namely, an entering stroke from the piston cylinder top to the piston cylinder bottom may correspond to an upper half of the circumference, and an exiting stroke from the piston cylinder bottom to the piston cylinder top may correspond to a lower half of the circumference. ang_1 represents a first sensed signal. In the formula, the A TAN 2 function represents an arctangent operation performed on the sine Bx_n and the cosine By_n, and a value range of the arctangent function is +Pi radians. The arctangent radian value is multiplied by 180/Pi( ) to obtain a corresponding angle plus or minus 180 degrees. A modulo operation is performed on the angle with respect to 360, that is, a MOD(ref, 360) function converts an angle range of +180 degrees to an angle range of 0-360 degrees. The generated linear function ang_1 is shown in FIG. 6B.

Methods for processing data sent by the second sensing element 102 and the third sensing element 103 are the same as this method, and details are not repeated.

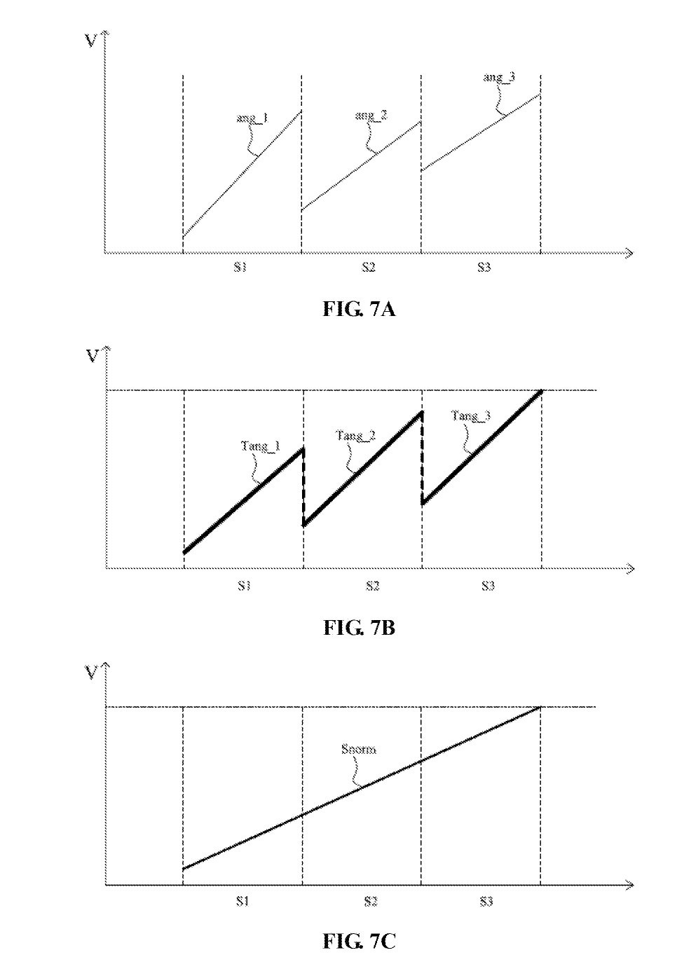

FIG. 7A is a schematic diagram of sensed signals, before temperature compensation, of three segments into which a stroke is divided according to an embodiment of the present invention.

The micro-processing unit 210 processes, as shown in FIG. 6A and FIG. 6B, all of the first periodic signals (Bx_1, By_1), the second periodic signals (Bx_2, By_2), and the third periodic signals (Bx_3, By_3) that are sent by the first sensing element 101, the second sensing element 102, and the third sensing element 103, and thereafter a schematic view of a signal structure shown in FIG. 7A is obtained.

In the drawing figures, the abscissa represents the stroke S divided into the first stroke S1, the second stroke S2, and the third stroke S3 respectively, and the ordinate represents a signal value V. In the figures, a first sensed signal ang_1 is represented in an area of the first stroke S1, a second sensed signal ang_2 is represented in an area of the second stroke S2, and a third sensed signal ang_3 is represented in an area of the third stroke S3. If the sensing elements are completely the same, the linear slopes of the sensed signals obtained by sensing a movement of a moving object at the same temperature are the same, and the three linear slopes are parallel with each other.

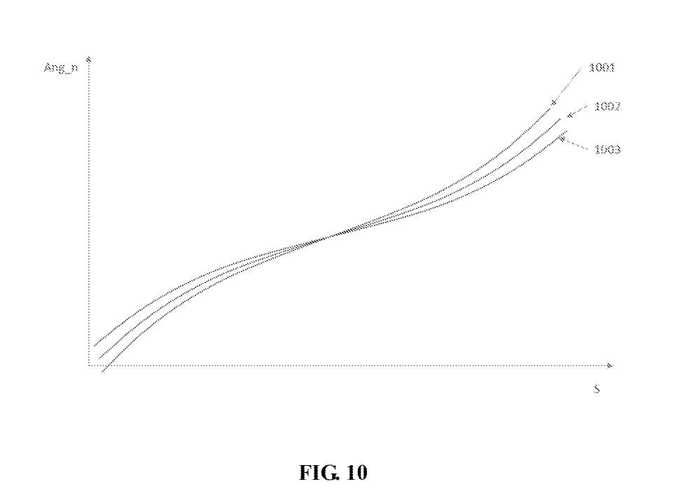

However, because physical properties of the sensing elements are different, a signal value ang_n sensed by a different Hall sensor at a different temperature will shift as the temperature changes (see FIG. 10 for details). Compared with a signal value V sensed at normal temperature, slopes of linear functions of the individual sensing elements represented by solid lines in FIG. 7A are different from each other. Properties of the individual sensing elements are different, and thus a change in the operating temperature leads to different Hall coefficients of the individual sensing elements, and the slopes of the generated linear functions are also different. The calculated functions may have the following cases shown in the figures: the slopes of the first sensed signal ang_1, the second sensed signal ang_2, and the third sensed signal ang_3 that have been changed are different. The sensed signals of different slopes may cause a non-smooth breakpoint in subsequent combination calculation, and superimposition will be enlarged during the combination.

FIG. 7B is a schematic diagram of temperature-compensated sensed signals obtained from each of the three segments into which a stroke is divided according to an embodiment of the present invention.

In order to solve the foregoing problem, temperature compensation correction needs to be performed on each sensed signal, to obtain functions of the same linear signal slope. A temperature sensing circuit shown in FIG. 5 is used to acquire a temperature signal of each sensing element; according to a property of each sensing element, a different temperature corresponds to a different Hall coefficient; and temperature compensation is performed on the sensed signal ang_n generated by the sensing element.

Taking the first sensing element 101 as an example, and the predetermined temperature compensation coefficients thereof are shown in the following table.

TABLE 1
Temperature Compensation Coefficient Table
of the First Sensing Element 101

| Temperature | Resistance | Voltage | | |
|---|---|---|---|---|
| (° C.) | (mΩ) | (mV) | Slope K | Intercept b |
| −40 | 791.3 | 1.865129873 | 1.2 | −0.01 |
| −35 | 816.2 | 1.901500326 | 1.184615 | −0.009230769 |
| −30 | 841.5 | 1.937600737 | 1.169231 | −0.008461538 |
| −25 | 867 | 1.973145198 | 1.153846 | −0.007692308 |
| −20 | 893 | 2.008547009 | 1.138462 | −0.006923077 |
| −15 | 919.2 | 2.043393206 | 1.123077 | −0.006153846 |
| −10 | 945.8 | 2.077950611 | 1.107692 | −0.005384615 |
| −5 | 972.7 | 2.112185812 | 1.092308 | −0.004615385 |
| 0 | 1000 | 2.145922747 | 1.076923 | −0.003846154 |
| 5 | 1027.6 | 2.179334917 | 1.061538 | −0.003076923 |
| 10 | 1055.5 | 2.21232446 | 1.046154 | −0.002307692 |
| 15 | 1083.8 | 2.245007871 | 1.030769 | −0.001538462 |
| 20 | 1112.4 | 2.277268261 | 1.015385 | −0.000769231 |
| 25 | 1141.3 | 2.309108566 | 1 | 0 |
| 30 | 1170.6 | 2.340638247 | 0.992 | 0.0004 |
| 35 | 1200.2 | 2.371749269 | 0.984 | 0.0008 |
| 40 | 1230.1 | 2.402445217 | 0.976 | 0.0012 |
| 45 | 1260.4 | 2.432828907 | 0.968 | 0.0016 |
| 50 | 1291.1 | 2.462897257 | 0.96 | 0.002 |
| 55 | 1322 | 2.492458522 | 0.952 | 0.0024 |
| 60 | 1353.4 | 2.521800701 | 0.944 | 0.0028 |
| 65 | 1385.1 | 2.55073478 | 0.936 | 0.0032 |
| 70 | 1417.2 | 2.579353524 | 0.928 | 0.0036 |
| 75 | 1449.7 | 2.607655502 | 0.92 | 0.004 |
| 80 | 1482.5 | 2.635555556 | 0.912 | 0.0044 |
| 85 | 1515.7 | 2.663140879 | 0.904 | 0.0048 |
| 90 | 1549.3 | 2.690410864 | 0.896 | 0.0052 |
| 95 | 1583.4 | 2.717443537 | 0.888 | 0.0056 |
| 100 | 1087.8 | 2.744080331 | 0.88 | 0.006 |
| 105 | 1652.6 | 2.770401663 | 0.872 | 0.0064 |
| 110 | 1687.9 | 2.796480997 | 0.864 | 0.0068 |
| 115 | 1723.6 | 2.822242599 | 0.856 | 0.0072 |
| 120 | 1759.7 | 2.847687478 | 0.848 | 0.0076 |
| 125 | 1796.3 | 2.87288488 | 0.84 | 0.008 |
| 130 | 1833.3 | 2.897764992 | 0.832 | 0.0084 |
| 135 | 1870.9 | 2.922459308 | 0.824 | 0.0088 |
| 140 | 1908.9 | 2.946833802 | 0.816 | 0.0092 |
| 145 | 1947.4 | 2.970952584 | 0.808 | 0.0096 |
| 150 | 1986.3 | 2.994753189 | 0.8 | 0.01 |

In Table 1, the first column is operating temperatures of the first sensing element 101, the second column is different resistance values of the thermistor 510, the third column is voltage signals input to the micro-processing unit 210 after the thermistor 510 voltage division, a slope K is a corresponding temperature compensation coefficient, and an intercept b is a temperature compensation intercept.

Calculation of temperature compensation performed on the first sensed signal ang_1 is used as an example. A calculation formula is as follows:

Tang_1=K×ang_1+b

where K is a temperature compensation coefficient, b is an intercept, ang_1 is the first sensed signal, and Tang_1 is a first compensated sensed signal.

Temperature compensation calculation methods for the second sensed signal ang_2 and the third sensed signal ang_3 are similar to this method. When the same sensing elements are used, temperature compensation calculation methods of the individual sensed signals are also the same.

The first compensated sensed signal Tang_1, a second compensated sensed signal Tang_2, and a third compensated sensed signal Tang_3 obtained through temperature compensation are represented by solid line segments in FIG. 7B. As shown in FIG. 7B, after temperature compensation is performed on the first sensed signal ang_1, the second sensed signal ang_2, and the third sensed signal ang_3, the first compensated sensed signal Tang_1, the second compensated sensed signal Tang_2, and the third compensated sensed signal Tang_3 with the same linear signal slope are obtained.

In the present invention, a linear function reflecting the movement of the piston 109 in the entire stroke needs to be finally formed through end to end connection. Obviously, the first compensated sensed signal Tang_1, the second compensated sensed signal Tang_2, and the third compensated sensed signal Tang_3 need to be adjusted and corrected. The first compensated sensed signal Tang_1 is still used as an example, and a correction adjustment calculation formula for the first compensated sensed signal Tang_1 is:

Lin_1=S1×Tang_1+I1

where Lin_1 is a first corrected sensed signal obtained through correction, S1 is a slope adjustment correction coefficient of the first compensated sensed signal, and I1 is an intercept adjustment coefficient of the first compensated sensed signal. The slope adjustment correction coefficient Sn and the intercept adjustment coefficient In are calculated by a processor.

The second compensated sensed signal Tang_2 and the third compensated sensed signal Tang_3 may also be adjusted by using the same correction formula. A first corrected sensed signal, a second corrected sensed signal, a third corrected sensed signal obtained through adjustment are shown in FIG. 7C.

FIG. 7C is a schematic diagram of temperature-compensated sensed signals obtained from each of the three segments into which a stroke is divided according to the foregoing embodiment of the present invention.

FIG. 7C shows the first corrected sensed signal Lin_1, the second corrected sensed signal Lin_2, and the third corrected sensed signal Lin_3 obtained through adjustment, which are movement position signals with the same slope, an end to end connection, and no intermediate breakpoint. The first corrected sensed signal Lin_1, the second corrected sensed signal Lin_2, and the third corrected sensed signal Lin_3 are combined according to a stroke sequence to obtain a final output signal Snorm, and a specific calculation formula is:

Snorm=Lin_1+Lin_2+Lin_3

where Snorm is a combined movement position signal according to a piston movement stroke and continuous timing.

The micro-processing unit 210 sends the combined piston movement position signal Snorm to the ECU 207.

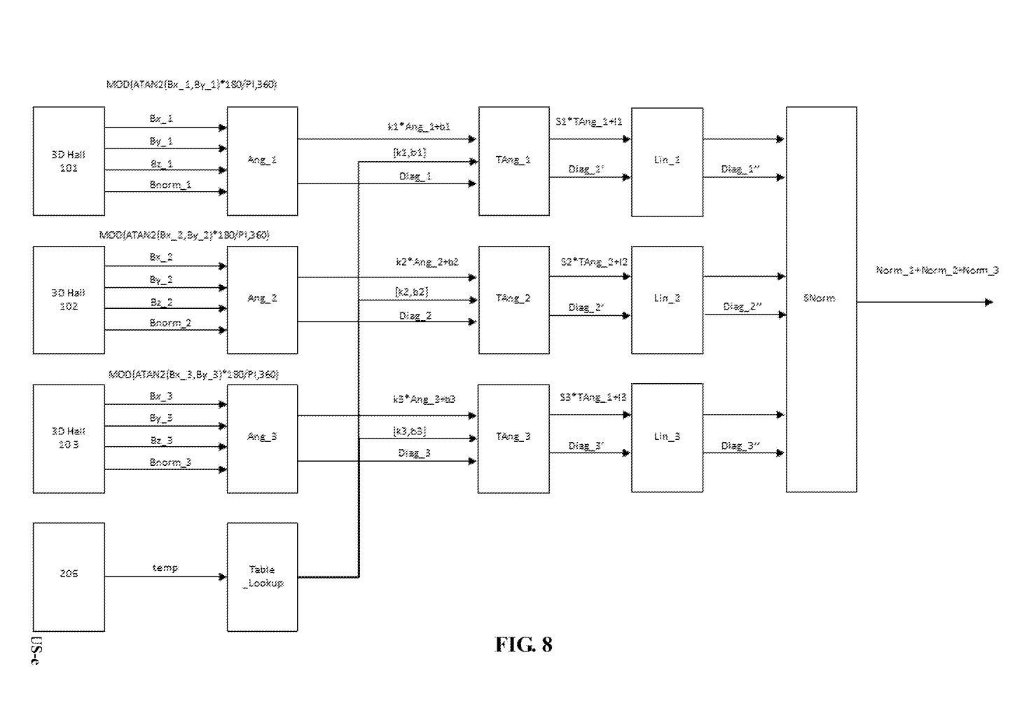

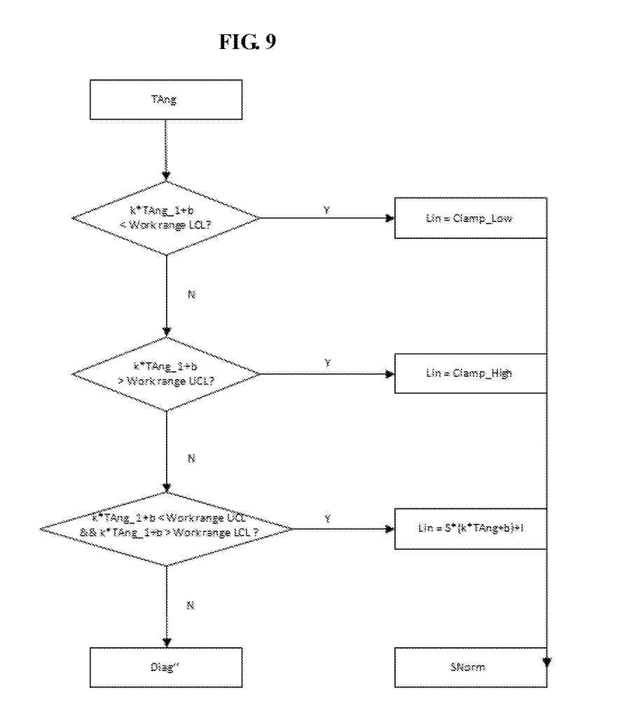

FIG. 8 is a schematic flowchart of a signal processing method according to the present invention.

As described above, the three 3D Hall sensing elements 101, 102, and 103 sense and obtain first periodic signals (Bx_1, By_1), second periodic signals (Bx_2, By_2), and third periodic signals (Bx_3, By_3). By using the following formula:

(1) Ang_n=MOD(A TAN 2(Bx_1,By_1)*180/PI,360, where n is an integer greater than or equal to 1;

a first sensed signal ang_1, a second sensed signal ang_2, and a third sensed signal ang_3 are obtained, and meanwhile, the temperature sensing circuit 206 acquires and obtains a temperature signal of each sensing element. A temperature compensation coefficient K and a temperature compensation intercept b of each sensing element are obtained by searching the table. By using the following formula:

(2) Tang_n=K×ang_n+b, where n is an integer greater than or equal to 1;

a first compensated sensed signal Tang_1, a second compensated sensed signal Tang_2, and a third compensated sensed signal Tang_3 are obtained. The first compensated sensed signal Tang_1, the second compensated sensed signal Tang_2, and the third compensated sensed signal Tang_3 need to be combined and superimposed, and therefore need to be adjusted again by using the following formula:

(3) Lin_n=Sn×Tang_n+In, where n is an integer greater than or equal to 1;

a first corrected sensed signal Lin_1, a second corrected sensed signal Lin_2, and a third corrected sensed signal Lin_3 are obtained. The first corrected sensed signal Lin_1, the second corrected sensed signal Lin_2, and the third corrected sensed signal Lin_3 are superimposed according to a stroke sequence by using the following formula:

(4) Snorm=Lin_1+Lin_2+Lin_3+Lin_4+ . . . +Lin_n, where n is an integer greater than or equal to 1;

a combined piston movement position signal Snorm output from the micro-processing unit 210 to the ECU 207 is finally obtained.

FIG. 9 is a schematic flowchart of detection and diagnosis processing performed on a corrected sensed signal according to the present invention;

As shown in FIG. 9, the microcontrol unit 210 performs diagnosis on a corrected sensed signal Lin_n. The diagnosis is performed by using the following comparison formulas:

(1) If Lin_n<Work range LCL, output Lin_n=Clamp_Low;

(2) If Lin_n>Work range LCL, output Lin_n=Clamp_High; and

(3) If Work range LCL>Lin_n<Work range UCL, output Lin_n=Sn×Tang+In,

where Clamp_Low represents a signal output low clamp mode, Clamp_High represents a signal output high clamp mode, Work range LCL represents a minimum effective work range, and Work range UCL represents a maximum effective work range. Therefore, only when the corrected sensed signal Lin_n is between the minimum effective work range and the maximum effective work range, the corrected Lin_n=Sn×Tang+In signal is output.

FIG. 10 is a schematic waveform diagram of sensed signals at different temperatures according to the present invention.

As illustrated in FIG. 7A described above, the properties of the individual sensing elements are different, and thus different operating temperatures will cause different Hall coefficients of the sensing elements, and the slopes of the generated linear functions are different too. Three curves 1001, 1002, and 1003 in FIG. 10 represent outputs of a sensed signal ang_n of the same Hall sensing element at temperatures of −40° C., 25° C., and 150° C. respectively. The lower the temperature is, the greater the slope is, and vice versa.

By measuring output signals of sensing elements at different temperatures, a temperature compensation coefficient table of each sensing element can be established, corresponding to different correction coefficients.

Although the present invention has been described with reference to the specific embodiments shown in the accompanying drawings, it should be understood that the clutch piston position sensor and system of the present invention may have many variations without departing from the spirit and scope of the present invention. Persons of ordinary skill in the art also would realize that various modifications may be made to the parameters in the embodiments disclosed by the present invention, such as sizes, shapes, or types of elements or materials, which should all fall within the spirit and scope of the present invention and the claims.

What is claimed is:

1. A method for sensing position of a moving object, used to sense a movement position of a moving object in one stroke, wherein a length of the stroke is divided into at least two strokes (S1, S2), and the moving object moves in the stroke to generate a movement position signal (yd1) of the moving object in the first stroke (S1) and a movement position signal (yd2) of the moving object in the second stroke (S2); the sensing method comprising:
sensing the movement position signal (yd1) of the moving object in the first stroke (S1) and the movement position signal (yd2) of the moving object in the second stroke (S2), and generating a first sensed signal (ang_1) and a second sensed signal (ang_2) respectively, wherein the first sensed signal (ang_1) and the second sensed signal (ang_2) change as the moving object moves in the corresponding first stroke (S1) and the corresponding second stroke (S2); and
combining the first sensed signal (ang_1) and the second sensed signal (ang_2) according to a stroke sequence (or time) to generate a whole sensed signal (Snorm), wherein the whole sensed signal (Snorm) changes as the moving object moves in the stroke.

2. The sensing method according to claim 1, further comprising:
disposing a first sensing element corresponding to the first stroke (S1), wherein the first sensing element is configured to sense a movement of the moving object passing through the first stroke (S1), and generate the first sensed signal (ang_1); and
disposing a second sensing element corresponding to the second stroke (S2), wherein the second sensing element is configured to sense a movement of the moving object passing through the second stroke (S2), and generate the second sensed signal (ang_2).

3. The sensing method according to claim 2, further comprising:
the first sensing element sensing in two-dimensional spatial direction, the movement of the moving object in the first stroke (S1) to generate sine-shaped and cosine-shaped first periodic signals (Bx_1, By_1) reflecting the movement of the moving object in the first stroke (S1); and
the second sensing element sensing, in two-dimensional spatial direction, the movement of the moving object in the second stroke (S2) to generate sine-shaped and cosine-shaped second periodic signals (Bx_2, By_2) reflecting the movement of the moving object in the second stroke (S2).

4. The sensing method according to claim 3, further comprising:
performing analog-to-digital conversion on the first periodic signals (Bx_1, By_1) sensed by the first sensing element; and
performing analog-to-digital conversion on the second periodic signals (Bx_2, By_2) sensed by the second sensing element.

5. The sensing method according to claim 4, further comprising:
converting the digital sine-shaped and cosine-shaped first periodic signals (Bx_1, By_1) to the linear first sensed signal (ang_1); and
converting the digital sine-shaped and cosine-shaped second periodic signals (Bx_2, By_2) to the linear second sensed signal (ang_2).

6. The sensing method according to claim 5, further comprising:
sensing an ambient temperature of the sensing elements to obtain an ambient temperature signal (Temp); and
performing temperature compensation on the first sensed signal (ang_1) and the second sensed signal (ang_2) according to the ambient temperature signal (Temp) to obtain a first compensated sensed signal (Tang_1) and a second compensated sensed signal (Tang_2) with the same linear signal slope that are obtained through the temperature compensation.

7. The sensing method according to claim 6, further comprising:
storing different temperature compensation coefficients corresponding to different ambient temperature signals; and
performing the temperature compensation on the first sensed signal (ang_1) and the second sensed signal (ang_2) according to different temperature compensation coefficients to obtain the first compensated sensed signal (Tang_1) and the second compensated sensed signal (Tang_2).

8. The sensing method according to claim 7, wherein the temperature compensation is performed by using the following calculation formula:
Tang_n=K×ang_n+b;
wherein K is a temperature compensation coefficient, b is an intercept, n is an integer greater than or equal to 1, ang_n is an nth sensed signal, and Tang_n is an nth compensated sensed signal.

9. The sensing method according to claim 7, further comprising:
correcting the first compensated sensed signal (Tang_1) and the second compensated sensed signal (Tang_2) to obtain a first corrected sensed signal (Lin_1) and a second corrected sensed signal (Lin_2) respectively;
combining the first corrected sensed signal (Lin_1) and the second corrected sensed signal (Lin_2) according to a stroke sequence; and
generating a linear whole sensed signal (Snorm) reflecting the movement of the moving-object in the entire stroke.

10. The sensing method according to claim 9, wherein the correcting the first compensated sensed signal (Tang_1) and the second compensated sensed signal (Tang_2) is performed by using the following calculation formula:
Lin_n=Sn×Tang_n+In;
wherein Lin_n is an nth corrected sensed signal obtained through correction, Sn is a slope correction coefficient of an nth compensated sensed signal, In is an intercept adjustment coefficient of the nth compensated sensed signal, and n is an integer greater than or equal to 1.

11. The sensing method according to claim 9, wherein the linear first corrected sensed signal (Lin_1) and the linear second corrected sensed signal (Lin_2) obtained through compensation and correction are combined according to the stroke sequence, wherein the combination according to the stroke sequence is performed by using the following calculation formula:
Snorm=Lin_1+Lin_2+Lin_3+Lin_4+ . . . +Lin_n;
wherein n is an integer greater than or equal to 1, and Snorm is a combined movement position signal.

12. The sensing method according to claim 10, further comprising:
performing diagnosis on the corrected sensed signal (Lin_n), wherein the diagnosis is performed by using the following comparison formulas:
(1) if Lin_n<Work range LCL, output Lin_n=Clamp_Low;
(2) if Lin_n>Work range LCL, output Lin_n=Clamp_High; and
(3) if Work range LCL>Lin_n<Work range UCL, output Lin_n=Sn×Tang+In;
wherein Clamp_Low represents a signal output low clamp mode, Clamp_High represents a signal output high clamp mode, Work range LCL represents a minimum effective work range, and Work range UCL represents a maximum effective work range.

13. A system for sensing position of a moving object, used to sense a movement position of a moving object in one stroke, wherein a length of the stroke is divided into at least two strokes (S1, S2), the moving object moves in the stroke to generate a movement position signal (yd1) of the moving object in the first stroke (S1) and a movement position signal (yd2) of the moving object in the second stroke (S2); the sensing system comprising:
multiple sensing elements, configured to sense the movement position signal (yd1) of the moving object in the first stroke (S1) and the movement position signal (yd2) of the moving object in the second stroke (S2), and generate a first sensed signal (ang_1) and a second sensed signal (ang_2) respectively, wherein the first sensed signal (ang_1) and the second sensed signal (ang_2) change as the moving object moves in the corresponding first stroke (S1) and the corresponding second stroke (S2); and
a microcontrol unit, configured to combine the first sensed signal (ang_1) and the second sensed signal (ang_2) according to a stroke sequence (or time) to generate a whole sensed signal (Snorm), wherein the whole sensed signal (Snorm) changes as the moving object moves in the stroke.

14. The sensing system according to claim 13, wherein:
the sensing elements comprise a first sensing element and a second sensing element;
the first sensing element is disposed in the first stroke (S1), and is configured to sense a movement of the moving object passing through the first stroke (S1), and generate the first sensed signal (ang_1); and
the second sensing element is disposed in the second stroke (S2), and is configured to sense a movement of the moving object passing through the second stroke (S2), and generate the second sensed signal (ang_2).

15. The sensing system according to claim 14, wherein:
the first sensing element senses, in two directions of two-dimensional space, a movement of the moving object in the first stroke (S1) to generate sine-shaped and cosine-shaped first periodic signals (Bx_1, By_1) that reflect the movement of the magnet apparatus in the first stroke (S2); and
the second sensing element senses, in the two directions of the two-dimensional space, a movement of the moving object in the second stroke to generate sine-shaped and cosine-shaped second periodic signals (Bx_2, By_2) that reflect the movement of the magnet apparatus in the second stroke (S2).

16. The sensing system according to claim 15, wherein:
the microcontrol unit performs analog-to-digital conversion on the sensed first periodic signals (Bx_1, By_1); and
the microcontrol unit performs analog-to-digital conversion on the sensed second periodic signals (Bx_2, By_2).

17. The sensing system according to claim 16, wherein:
the microcontrol unit converts the digital sine-shaped and cosine-shaped first periodic signals (Bx_1, By_1) to the linear first sensed signal (ang_1); and
the microcontrol unit converts the digital sine-shaped and cosine-shaped second periodic signals (Bx_2, By_2) to the linear second sensed signal (ang_2).

18. The sensing system according to claim 17, further comprising a temperature sensing circuit, wherein
the temperature sensing circuit senses an ambient temperature of the sensing elements to obtain an ambient temperature signal (Temp); and
the microcontrol unit performs temperature compensation on the first sensed signal (ang_1) and the second sensed signal (ang_2) according to the ambient temperature signal (Temp) to obtain a first compensated sensed signal (Tang_1) and a second compensated sensed signal (Tang_2) with the same linear signal slope that are obtained through the temperature compensation.

19. The sensing system according to claim 18, wherein:
the microcontrol unit stores different temperature compensation coefficients corresponding to different ambient temperature signals; and
the microcontrol unit performs the temperature compensation on the first sensed signal (ang_1) and the second sensed signal (ang_2) according to different temperature compensation coefficients to obtain the first compensated sensed signal (Tang_1) and the second compensated sensed signal (Tang_2).

20. The sensing system according to claim 18, wherein:
the microcontrol unit performs the temperature compensation by using the following calculation formula:
Tang_n=K×ang_n+b;
wherein K is a temperature compensation coefficient, b is an intercept, n is an integer greater than or equal to 1, ang_n is an nth sensed signal, and Tang_n is an nth compensated sensed signal.

21. The sensing system according to claim 18, wherein:
the microcontrol unit corrects the first compensated sensed signal (Tang_1) and the second compensated sensed signal (Tang_2) to obtain a first corrected sensed signal (Lin_1) and a second corrected sensed signal (Lin_2) respectively; and
the microcontrol unit combines the first corrected sensed signal (Lin_1) and the second corrected sensed signal (Lin_2) according to a stroke sequence, and generates a linear whole sensed signal (Snorm) reflecting the movement of the piston in the entire stroke.

22. The sensing system according to claim 21, wherein the microcontrol unit corrects the first compensated sensed signal (Tang_1) and the second compensated sensed signal (Tang_2) by using the following calculation formula:
Lin_n=Sn×Tang_n+In;
wherein Lin_n is an nth corrected sensed signal obtained through correction, Sn is a slope correction coefficient of an nth compensated sensed signal, In is an intercept adjustment coefficient of the nth compensated sensed signal, and n is an integer greater than or equal to 1.

23. The sensing system according to claim 21, wherein the microcontrol unit combines, according to the stroke sequence in a time sharing manner, the first corrected sensed signal (Lin_1) and the second corrected sensed signal (Lin_2) that are obtained through correction, wherein the combination according to the stroke sequence is performed by using the following calculation formula:
Snorm=Lin_1+Lin_2+Lin_3+Lin_4+ . . . +Lin_n;
wherein n is an integer greater than or equal to 1, and Snorm is a combined movement position signal.

24. The sensing system according to claim 21, wherein:
the microcontrol unit performs diagnosis on the corrected sensed signal (Lin_n); and
the diagnosis is performed by using the following comparison formulas:
(1) if Lin_n<Work range LCL, output Lin_n=Clamp_Low;
(2) if Lin_n>Work range LCL, output Lin_n=Clamp_High; and
(3) if Work range LCL>Lin_n<Work range UCL, output Lin_n=Sn×Tang+In;
wherein Clamp_Low represents a signal output low clamp mode, Clamp_High represents a signal output high clamp mode, Work range LCL represents a minimum effective work range, and Work range UCL represents a maximum effective work range.

25. The sensing system according to claim 13, further comprising a sleep control circuit, provided with a sleep sensing element, and configured to sense a position of the moving object and generate a sleep control signal, wherein the microcontrol unit receives the sleep control signal to control the sensing system to be in a started or sleep mode.

26. The sensing system according to claim 25, wherein:
the sleep control circuit senses the position of the moving object; and
when the moving object is driven to a first set position, the sleep control circuit sends a startup control signal; and
when the moving object is driven to a second set position, the sleep control circuit sends the sleep control signal.

27. The sensing system according to claim 26, wherein:
the startup control signal is a rising edge step signal, and after receiving the startup control signal, the microcontrol unit enables the sensing system to output a normal signal after outputting a startup first character for 1 ms; and
the sleep control signal is a falling edge step signal, and after receiving the sleep control signal, the microcontrol unit enables the sensing system to output no signal after outputting the normal signal for 2.5 ms.

28. The sensing system according to claim 13, wherein the moving object is a clutch piston, and the stroke is a movable distance of the clutch piston in a piston cylinder.

29. A clutch piston position sensing system with a sleep function, configured to sense a movement position of a clutch piston in one stroke, the sensing system comprising:
a magnet apparatus, disposed on the piston and moving along with the piston in the stroke;
a sleep control circuit, provided with a sleep sensing element, and configured to sense a position of the magnet apparatus and generate a sleep control signal to control the clutch piston position sensing system to be in a started or sleep mode; and
a microcontrol unit, configured to receive the sleep control signal and control the clutch piston position sensing system to be in a sleep or started state.

30. The sensing system according to claim 29, wherein the sleep control circuit senses a position of the piston;
when the piston is driven to a first set position, the sleep control circuit sends a startup control signal; and
when the piston is driven to a second set position, the sleep control circuit sends the sleep control signal.

31. The sensing system according to claim 30, wherein:
the startup control signal is a rising edge step signal, and after receiving the startup control signal, the microcontrol unit enables the clutch piston position sensing system to output a normal signal after outputting a startup first character of 1 ms; and
the sleep control signal is a falling edge step signal, and after receiving the sleep control signal, the microcontrol unit enables the clutch piston position sensing system to output no signal after outputting a normal signal of 2.5 ms.

32. The sensing system according to claim 30, wherein:
the microcontrol unit receives the startup control signal, and controls the clutch piston position sensing system to be in a started state; and
the microcontrol unit receives the sleep control signal, and controls the clutch piston position sensing system to be in a sleep state.

33. The sensing system according to claim 29, wherein a length of the stroke is divided into at least two strokes (S1, S2): a first stroke (S1) and a second stroke (S2) respectively; and the piston moves in the stroke to generate a movement position signal (yd1) of the piston in the first stroke (S1) and a movement position signal (yd2) of the piston in the second stroke (S2).

34. The sensing system according to claim 33, further comprising sensing elements, configured to sense the movement position signal (yd1) of the piston in the first stroke (S1) and the movement position signal (yd2) of the piston in the second stroke (S2) respectively, and generate a first sensed signal (ang_1) and a second sensed signal (ang_2), wherein
the first sensed signal (ang_1) and the second sensed signal (ang_2) change as the piston moves in the corresponding first stroke (S1) and the corresponding second stroke (S2); and
microcontrol unit configured to combine the first sensed signal (ang_1) and the second sensed signal (ang_2) according to a stroke sequence to generate a whole sensed signal (Snorm) where the whole sensed signal (Snorm) changes as the piston moves in the stroke.

35. The sensing system according to claim 29, further comprising:
sensing elements, fixedly mounted on the clutch piston cylinder; and
a magnetism aggregation member, additionally provided outside the piston cylinder and configured to enhance magnetic field extension strength of the magnet apparatus.
